(19) United States
(12) Patent Application Publication
(10) Pub. No.: US 2012/0022946 A1
(43) Pub. Date: Jan. 26, 2012

(54) Hierarchical User Interface of a Computing Device For Determining Interest Level of a User in Categories of Advertisement

(76) Inventor: Yang Pan, Singapore (SG)

(21) Appl. No.: 12/843,005

(22) Filed: Jul. 24, 2010

(51) Int. Cl. G06Q 30/00

(52) U.S. Cl. 705/14.55

(57) ABSTRACT

A hierarchical user interface for determining a user's interest level in categories of advertisements is disclosed. Multiple user selectable icons may be displayed in association with each category of advertisements. An icon is selected and is associated with a user adjustable visual sign indicating the user's interest level in a quantitative manner. Scores for each category or each sub-category of advertisements are determined based upon the user's inputs. Advertisements are delivered to the user according to the scores.

### CROSS-REFERENCE TO RELATED APPLICATIONS

Not applicable.

### BACKGROUND

1. Field of Invention

This invention relates generally to advertising. More specifically, the invention relates to methods for delivering advertising messages more effectively to a user based on a hierarchical user interface for determining interest levels of the user in categories or sub-categories of advertisements.

2. Description Of Prior Art

Advertising using traditional media, such as television, radio, newspapers and magazines, is well known. Unfortunately, even when armed with demographic studies and entirely reasonable assumptions about the typical audience of various media outlets, advertisers recognize that much of their advertisement budget is simply wasted. Moreover, it is difficult to identify and eliminate such waste.

Mobile communication devices have gained significant popularity in recent years. Users are using the mobile device such as, for example, iPhone from Apple Inc, Cupertino, Calif., to access the Internet services. Methods for delivering targeted advertisements to users by employing mobile communication devices have been developed. The targeted advertising messages may be delivered based upon the user's personal profile, location and history of the user's interaction with the device. It has always been a significant challenge to understand the user's real interests and to deliver the advertising message accordingly.

### SUMMARY

It is an object of the present invention to provide an advertisement delivery system for delivering highly targeted advertisements to a user of a computing device from a data manager in the Internet.

It is another object of the present invention to provide an effective method for determining a user's interests in categories or sub-categories of advertisements based on the user's inputs.

It is yet another object of the present invention to provide a hierarchical Graphic User Interface (GUI) for determining a user's interest in categories or sub-categories of advertisements in a progressive manner.

The hierarchical GUI comprises multiple levels. Each level includes one or multiple icons representing each category of advertisements. A user's selection of an icon results in associating the icon with a user adjustable visual sign. The visual sign may be movable along a displayed scale representing the user's interest level from 0% to 100% according to one implementation of the present invention.

After the user's interest level is determined, the next level of the user interface may be accessed by actuating one of the selected icons. The user's interest levels in the sub-categories of advertisements may be determined progressively by using the hierarchical GUI. Scores of each category and each sub-category may be determined. The advertisements may be delivered according to the scores.

### BRIEF DESCRIPTION OF THE DRAWINGS

For a more complete understanding of the present invention and its various embodiments, and the advantages thereof, reference is now made to the following description taken in conjunction with the accompanying drawings, in which:

FIG. 1 is a schematic diagram of an exemplary advertisement delivery system for delivering advertisements from advertisers to a user through a communication network;

FIG. 2 is a schematic diagram illustrating a hierarchical GUI in accordance with one embodiment;

FIG. 3 is a schematic presentation of metadata structure of a data file of an advertisement file;

FIG. 4 is a schematic diagram illustrating that data files for advertisements may be sorted according to their scores representing a user's interest;

FIG. 5 is a flowchart illustrating an exemplary process that the user's interest in a sub-category of advertisement is determined in a progressive manner by using the hierarchical GUI;

FIG. 6 is a flowchart illustrating a process that a data manager sends a request to update the user's interest profile through a communication network;

FIG. 7 is a flowchart illustrating a process that advertisements are delivered to the user of the computing device from a data manager based upon the calculated scores generated from the hierarchical user interface.

### DETAILED DESCRIPTION

One or more specific embodiments of the present invention will be described below. These described embodiments are only exemplary of the present invention. Additionally, in an effort to provide a concise description of these exemplary embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business related constraints, which may vary from one implementation to another. Moreover, it should be appreciated that such a development effort might be complex and time consuming, but would nevertheless be a routine undertaking of design, fabrication, and manufacture for those of ordinary skill having the benefits of this disclosure.

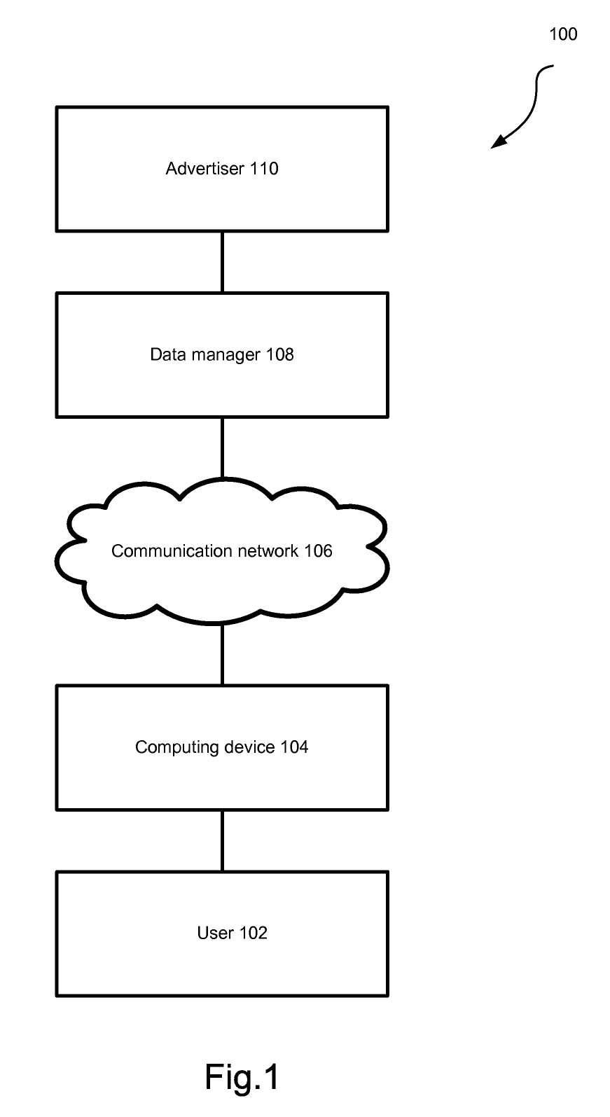

FIG. 1 is a schematic diagram of an exemplary advertisement delivery system for delivering advertisements from advertisers to a user through a communication network. The system 100 comprises a user 102 and a computing device 104. The computing device 104 may be a personal computer, a mobile communication device, a digital television system, a handheld media player; and a game console. The personal computer is used to illustrate exemplarily the present inventive concept without limiting the scope of the invention. The computing device 104 is connectable to a data manager 108 through a communication network 106. The communication network 106 may be the Internet. The network 106 may also be a public phone network or a broadband network for the digital television system for delivering TV programs. The data manager 108 may be a server connected to the network 106. The data manager 108 comprises an advertisement database including various categories of advertisements from advertiser 110. Multiple advertisers may be connected to the data manager 108. The data manager 108 may also be connected to manufacturers and customer rating and guiding organizations (not shown in the figure). The connections from the advertiser 100 to the data manager 108 may be through a communication network that is the same communication network as 106. The connections may be through a different communication network.

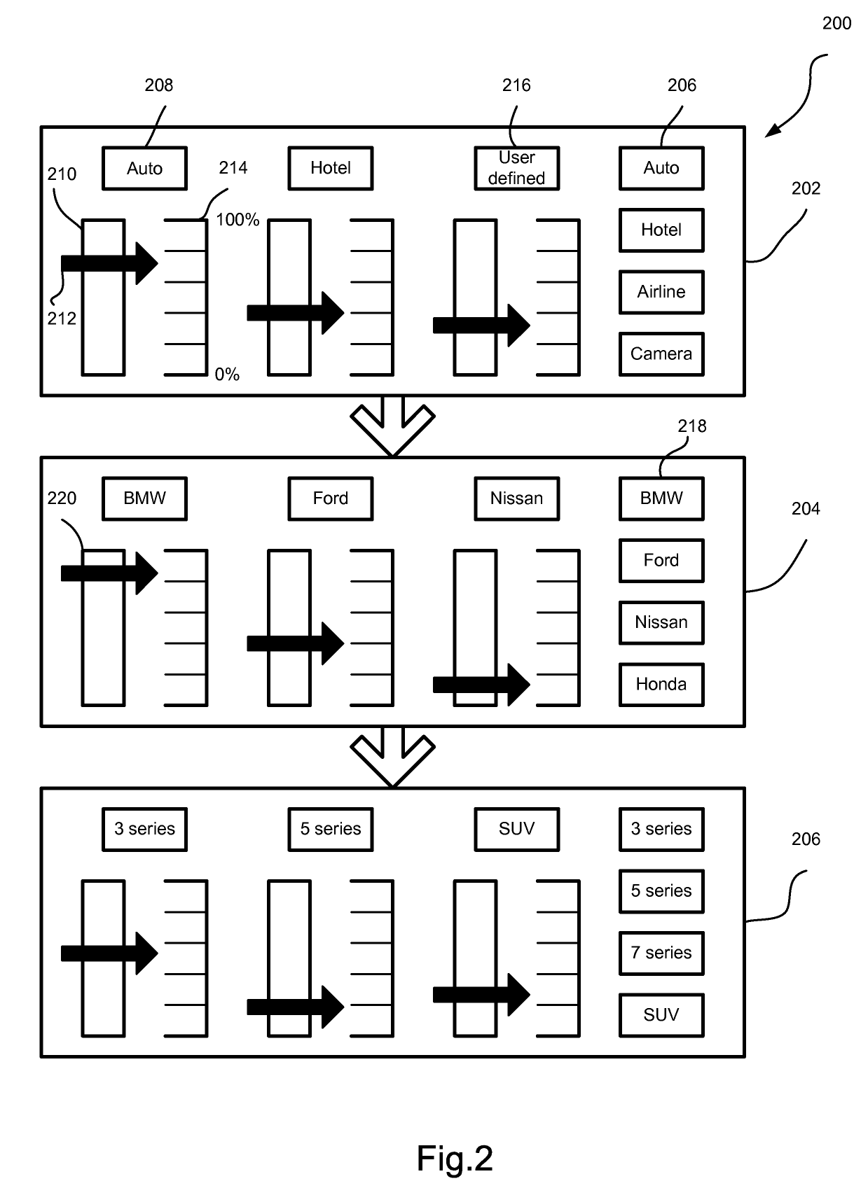

FIG. 2 is a schematic diagram illustrating a hierarchical GUI in accordance with one embodiment. The exemplary hierarchical GUI 200 comprises three levels 202, 204 and 206. More or less levels are all possible for the hierarchical GUI. The first level 202 of the GUI 200 comprises a group of displayed icons 206. Each icon represents a category of advertisements such as, for example, for automobiles, for hotels, for airlines and for cameras. A list of the icons may occupy multiple pages of the displayed window. When an icon such as the one (208) for the automobiles is selected, the icon is replicated on the top of a visual symbol 210. The visual symbol 210 comprises a user movable arrow 212 pointing to a vertical ruler 214 representing the user's interest scale from 0% to 100% in an exemplary case. The user may use a cursor controlled by an input device of the computing device 104 to move the arrow 212 up and down to reflect the user's interest level. The user interface 202 may also include a user definable icon 216. The user may key-in words for a specific category of advertisement interested to the user but not included in the group of icons 206.

After the user completes the operation of adjusting each arrow for each selected or defined icons, a score for each category of advertisements is generated and is recorded.

The user may move to the next hierarchical level user interface 204 by selecting one of selected icons. In an exemplary illustration, the icon representing the automobile is selected. The next level 204 may include a group of icons 218 representing brand names of automobile manufacturers such as, for example, BMW, Ford, Nissan and Honda. If the user selects BMW as an interested brand, the icon representing BMW is displayed on the top of a visual symbol 220. The user's interest may be determined in a similar manner as previously.

After the completion of actions related to the current level represented by 204, the user may further select an icon to go to the next level 206. A GUI is again displayed including the user selectable categories of BMW cars comprising the “3”, “5”, “7” series and the “SUV” in an exemplary illustration. The user may further select one of or several of the sub-categories and determine the interest level for each sub-category in a similar manner as in the level 202 and the level 204.

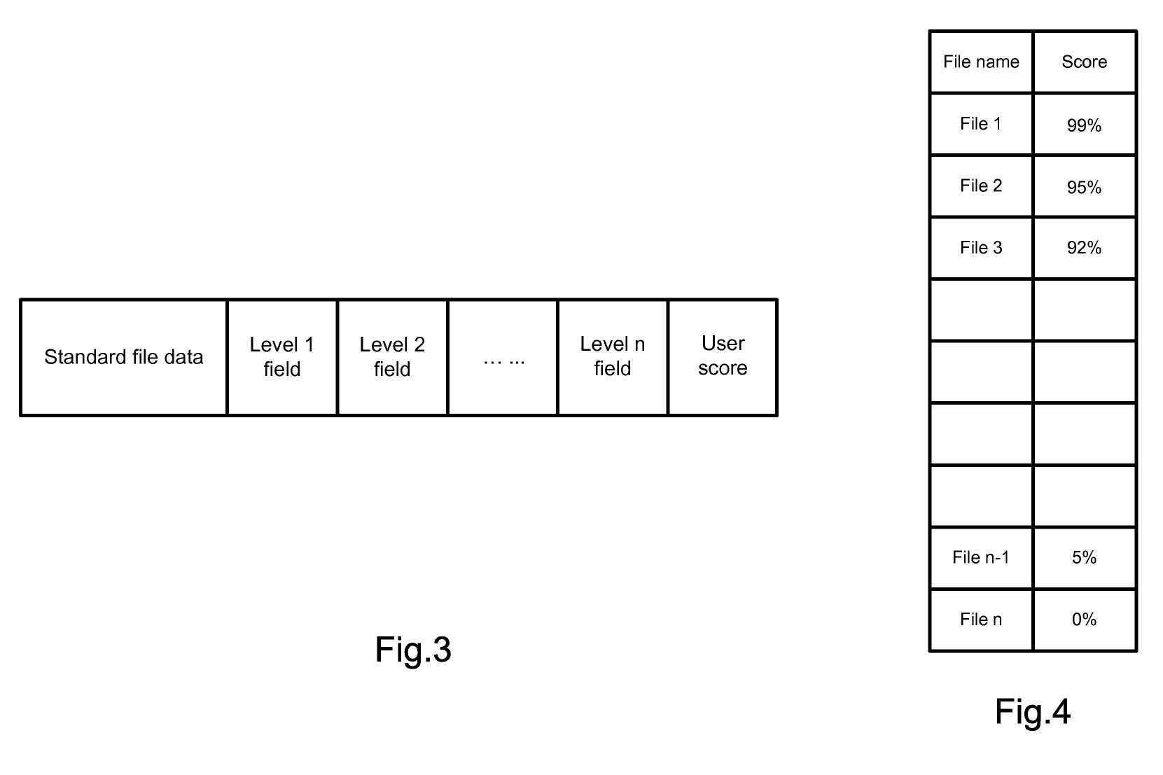

FIG. 3 is a schematic presentation of metadata structure of a data file of an advertisement. The metadata file structure may include standard fields as known in the art. The metadata file structure may further include fields for each of hierarchical levels of the advertisement. For example, for an automobile, the level 1 field may be filled as “automobile”, the level 2 field may be filled as “BMW”; and the level 3 field may be filled as “3 series”. The metadata fields may further include a field as “user score”. When the score for a specific file is determined through the use of the hierarchical GUI, the score may be recorded in the metadata of the advertisement file for a specific user. It should be noted that including the score in the data file is exemplary only. The data file may also not include such a field.

FIG. 4 is a schematic diagram illustrating in an exemplary manner that data files for advertisements may be sorted according to their scores representing a user's interests. For a specific user, a table may be generated ranking each data file of an advertisement according to its score.

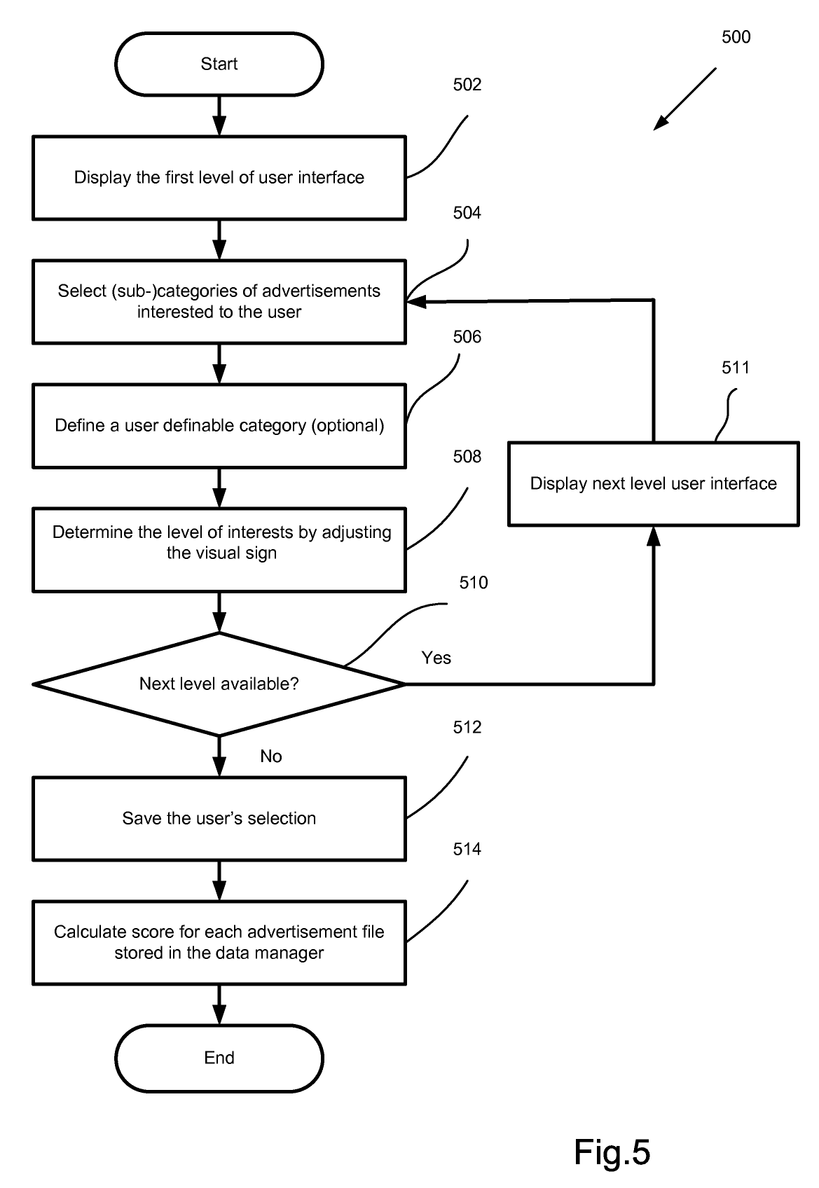

FIG. 5 is a flowchart illustrating an exemplary process that the user's interest in a sub-category of advertisement is determined in a progressive manner by using the hierarchical GUI. Process 500 starts with step 502 that the first level of the hierarchical GUI is displayed on a display screen of the computing device 104. In step 504, icons for one or more than one categories of advertisements are selected. The selected icons are associated with a visual sign with a user movable arrow, according to one implementation, indicating the user's interest level in a category of the advertisements. In an optional step 506, a user definable icon may be defined if the category is not included in a default list provided by the GUI. The user's interest levels in selected or defined categories are determined by moving the arrow up or down in step 508. If the user is decided to move to the next hierarchical level in step 510, the next level GUI is displayed in step 511. The steps from 504 to 510 are repeated. Otherwise, the user's interest file generated from the user's interaction with the hierarchical GUI is saved and sent to the data manager 108 through the Internet in an exemplary case in step 512. The scores for each stored advertisement in the data manager 108 are calculated in step 514.

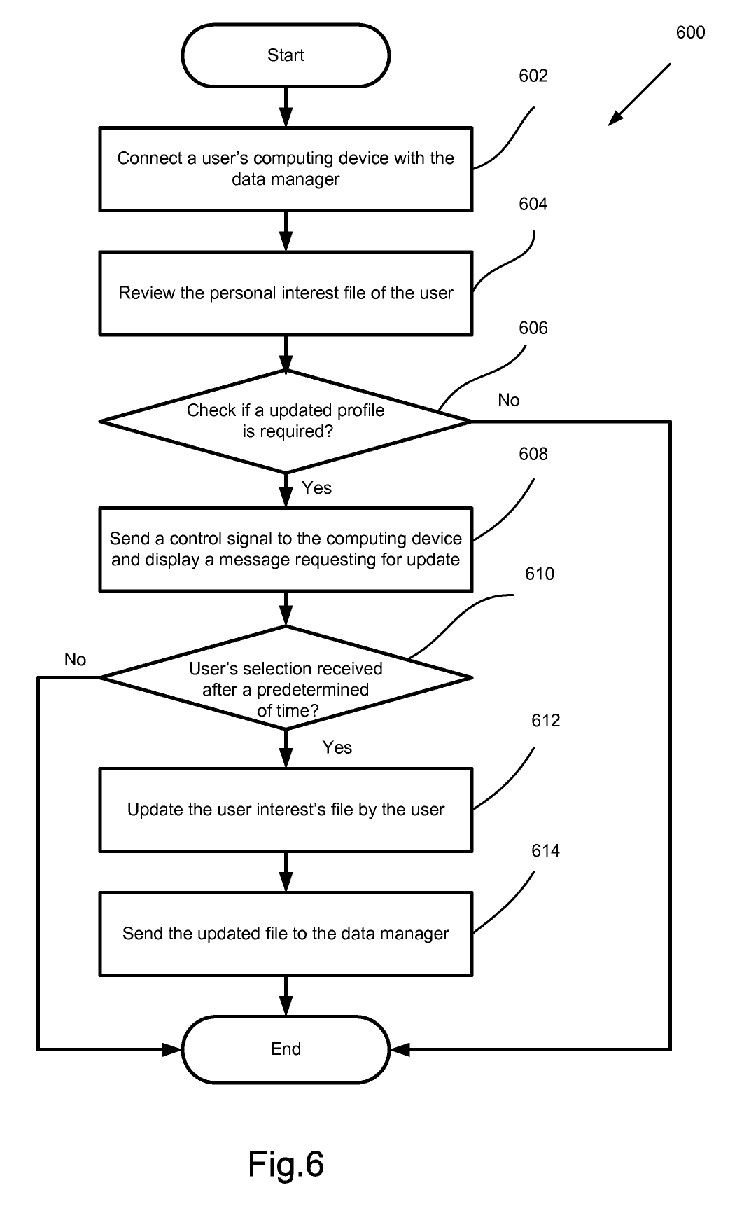

FIG. 6 is a flowchart illustrating a process that a data manager sends a request to update the user interest profile through a communication network. Process 600 starts with step 602 that the computing device 104 is connected to the data manager 108 through the communication network 106. The user's personal interest file is reviewed by the data manager 108 in step 604. If the data manager 108 decides that an update of the personal interest file is required in step 606, a control signal is sent to the computing device 104 from the data manager 108 through the network 106 in step 608. In step 610, if the user's selection to update the file is confirmed, the file is updated in step 612 by the user through the hierarchical GUI. The updated user interest file is then sent to the data manager 108 in step 614. The hierarchical GUI may be represented as an icon displayed on the home page of the computing device. In an exemplary implementation, the icon may be located at the bottom of the home page together with icons for other application programs.

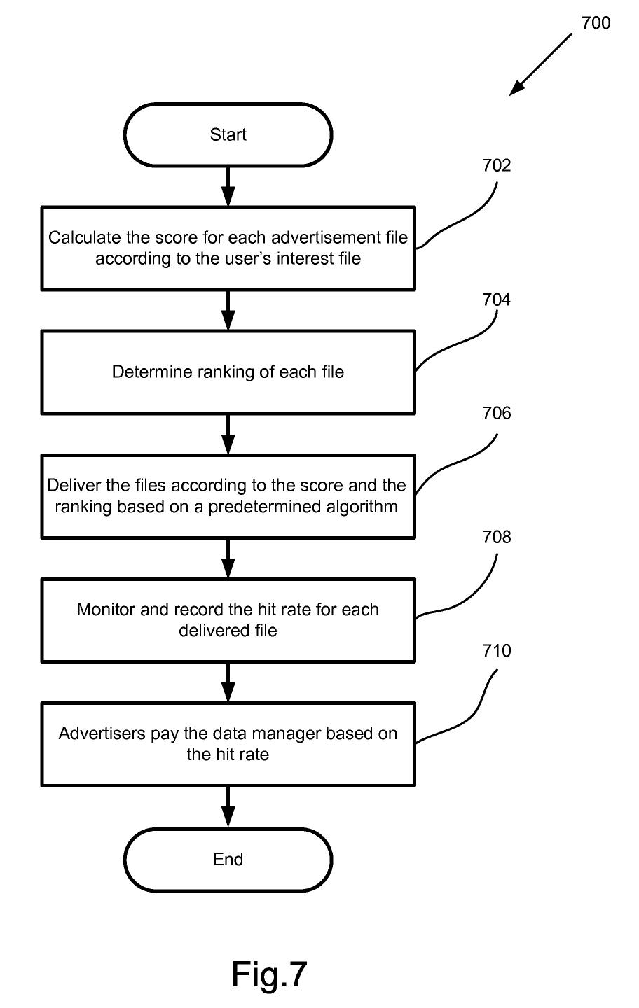

FIG. 7 is a flowchart illustrating a process that advertisements are delivered to the user of the computing device from a data manager based upon the calculated scores generated from the hierarchical GUI. Process 700 starts with step 702 that the score for each sub-category of advertisements are calculated. The priority ranking is determined in step 704 according to the scores. The advertisements are then delivered from the data manager 108 to the computing device 104 in step 706. The hit rate of each delivered advertising message is monitored and recorded in step 708. Advertisers 110 may pay the data manager 108 according to the recorded hot rate for each advertisement.

While the invention has been disclosed with respect to a limited number of embodiments, numerous modifications and variations will be appreciated by those skilled in the art. It is intended that all such variations and modifications fall within the scope of the following claims:

1. An advertisement delivery system comprising:
a computing device including a hierarchical user interface for determining a user's interests for categories of advertisements in a quantitative manner based upon the user's inputs;
a data manager including a plurality of advertisements; and
a communication network for connecting the computing device and the data manager.

2. The system as recited in claim 1, wherein the hierarchical user interface further comprising multiple levels.

3. The system as recited in claim 2, wherein said each level of the user interface further comprising a plurality of user selectable icons representing advertisement categories.

4. The system as recited in claim 2, wherein said each level of the user interface further comprising a user adjustable visual sign indicating visually the user's interest level in a selected category.

5. The system as recited in claim 4, wherein the user's interest level may be adjustable by the user from 0% to 100%.

6. The system as recited in claim 2, wherein said each level of the user interface further comprising a user definable icon representing a user definable advertisement category.

7. The system as recited in claim 1, wherein said data manager further comprising a means of delivering selected advertisements to the computing device according to scores for each category or sub-category of advertisements, wherein said scores are determined based upon the user's input (s) to said each level of the user interface.

8. The system as recited in claim 1, wherein said computing device further including a device selected from the following group:
a personal computer;
a mobile communication device;
a digital television system;
a media player; and
a game console.

9. The system as recited in claim 1, wherein said communication network further including a network from the following group:
the Internet;
a public telephone network with various communication standards as known in the art; and
a broadband television network

10. The system as recited in claim 1, wherein said data manager further including a means of connecting to a plurality of advertisers, and/or a plurality of manufactures; and/or a plurality of consumer rating/guiding organizations.

11. A hierarchical user interface of a computing device for determining a user's interest levels in categories of advertisements comprising one or more levels of the user interface, wherein said each level of the user interface further comprising a plurality of user selectable icons representing advertisement categories; and a user adjustable visual sign indicating visually the user's interest level in a selected category of the advertisements.

12. The interface as recited in claim 11, wherein said each level of the user interface further comprising a user definable icon representing a user definable advertisement category.

13. The interface as recited in claim 11, wherein said user interest level may be ranged from 0% to 100%.

14. The interface as recited in claim 11, wherein said user interface further comprising a means of determining a score representing the user's interest level in each category or sub-category of the advertisements.

15. The interface as recited in claim 11, wherein said computing device further including a device selected from the following group:
a personal computer;
a mobile communication device;
a digital television system;
a media player; and
a game console.

16. A method of determining a user's interest level in a quantitative manner in each of category and each of sub-category of advertisements comprising:
displaying a user interface including a plurality of user selectable icons representing advertisement categories and a user adjustable visual sign indicating visually the user's interest level in a selected category of the advertisements.
selecting one or more displayed icons;
associating each selected icon with one of the user adjustable visual signs;
adjusting the visual sign for indicating the user's interest level in the category; and
repeating step the above steps in a sequential manner until no more next level of the sub-category is available.

17. The method as recited in claim 16, wherein said method further comprising selecting a user definable icon and defining a category or sub-category of advertisements interested to the user.

18. The method as recited in claim 16, wherein said method further comprising calculating scores for each category and each sub-category of advertisements.

19. The method as recited in claim 18, wherein said method further comprising sending the scores to a data manager connected to the computing device through a communication network including the Internet.

20. The method as recited in claim 16, wherein said computing device further including a device selected from the following group:
a personal computer;
a mobile communication device;
a digital television system;
a media player; and
a game console.
